(19) United States
(12) Patent Application Publication
(10) Pub. No.: US 2023/0186871 A1
(43) Pub. Date: Jun. 15, 2023

(54) VISUAL CONTENT RENDERING FOR ELECTRONIC DISPLAY SYSTEM

(71) Applicant: Microsoft Technology Licensing, LLC, Redmond, WA (US)

(72) Inventors: Samu Matias Kallio, Redmond, WA (US); Joni Kristian Arola, Redmond, WA (US); Wenfeng Liu, Woodinville, WA (US)

(73) Assignee: Microsoft Technology Licensing, LLC, Redmond, WA (US)

(21) Appl. No.: 17/655,950

(22) Filed: Mar. 22, 2022

Related U.S. Application Data
(60) Provisional application No. 63/265,217, filed on Dec. 10, 2021.

(51) Int. Cl. G09G 5/22; G06F 1/16; G09G 5/00

(52) U.S. Cl. CPC G09G 5/227; G06F 1/1641; G06F 1/1681; G09G 5/006; G09G 2320/0613; G09G 2320/08

(57) ABSTRACT

An electronic display system includes a display controller configured to receive a first hinge angle between a first display and a second display pivotally coupled to the first display via a hinge. A first portion of the rendered visual content is displayed on the first display and a second portion of the rendered visual content is displayed on the second display, the first portion and the second portion having rendered sizes based at least in part on the first hinge angle.

### CROSS REFERENCE TO RELATED APPLICATIONS

This application claims priority to U.S. Provisional Patent Application No. 63/265,217, filed Dec. 10, 2021, the entirety of which is hereby incorporated herein by reference for all purposes.

### BACKGROUND

Electronic displays can be used to present visual content rendered by a computing system. Some computing systems may include two or more different electronic displays pivotally coupled via a hinge.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

An electronic display system includes a display controller configured to receive a first hinge angle between a first display and a second display pivotally coupled to the first display via a hinge. A first portion of the rendered visual content is displayed on the first display and a second portion of the rendered visual content is displayed on the second display, the first portion and the second portion having rendered sizes based at least in part on the first hinge angle.

### BRIEF DESCRIPTION OF THE DRAWINGS

FIGS. 1A and 1B schematically depict an example electronic display system.

FIGS. 2A and 2B schematically depict a side-view of an example electronic display system.

FIGS. 3A and 3B schematically illustrate first and second portions of rendered visual content having rendered sizes based on a hinge angle.

FIGS. 4A-4D schematically illustrate presentation of rendered visual content at two different hinge angles of an electronic display system.

FIGS. 5A and 5B schematically illustrate corner masking of visual content displayed by an example electronic display system.

FIG. 6 illustrates an example method for an electronic display system.

FIG. 7 schematically shows an example computing system.

### DETAILED DESCRIPTION

The present disclosure is directed to techniques for displaying rendered visual content on an electronic display system having two or more separate displays pivotally coupled via a hinge. Furthermore, at least a portion of each display in the proximity of the hinge may be non-planar. For instance, as will be described in more detail below, each display may comprise a flat portion and an edge portion that curves away from the flat portion, toward the hinge.

The total displayable area of the electronic display system may be affected by the current angle between two different displays—e.g., the curvature of the display surface near the hinge may make portions of each display difficult to see at some angles, and/or a portion of one display near the hinge may occlude part of another display at some viewing angles. In an example scenario where two displays are used cooperatively to display visual content (e.g., an image, a video frame, a user interface), reducing the angle between the two displays (e.g., folding the electronic display system toward a “closed” configuration, similar to closing a book) may result in relatively more of the display surface of one or both displays near the hinge becoming relatively more difficult to see. This can correspondingly affect visibility of any visual content presented near the hinge.

Thus, according to the techniques described herein, a display controller of the electronic display system may dynamically adjust a rendered size of visual content presented by two different displays of an electronic display system, based at least in part on a current angle between the two displays. For instance, as the angle between the two displays is reduced, the size of visual content presented by each display may be correspondingly reduced along one or more dimensions. In one example, this may be done by dynamically masking portions of each display in the vicinity of the hinge, where the size of each mask is based at least in part on the current angle between the displays. In some examples, this may provide a technical benefit of enabling the two displays to cooperatively present a single image, video, user interface, and/or other suitable visual content, without the appearance that part of the content near the hinge is missing or invisible due to the current angle between the displays.

As will be described in more detail below, the display controller may use any suitable calculations or relationships to determine the size of each portion of the visual content based at least in part on the current hinge angle of the electronic display system. As one example, based at least in part on a known structure of the electronic display system, and based at least in part on a known geometry of each display, the display controller may be programmed with an algorithm that outputs a target size of each portion of the visual content based at least in part on at least the hinge angle as an input. As another example, the display controller may maintain a look-up table that specifies target sizes for the different portions of the visual content for different hinge angles. Adjusting the size of different portions of rendered visual content as discussed herein may provide the technical benefits of tailoring the rendered visual content to the unique capabilities of the electronic display system, and/or improving human-computer interaction—for instance, reducing the burden of a user providing input to the electronic display system by positioning user interface elements at display positions where they are visible and/or interactable.

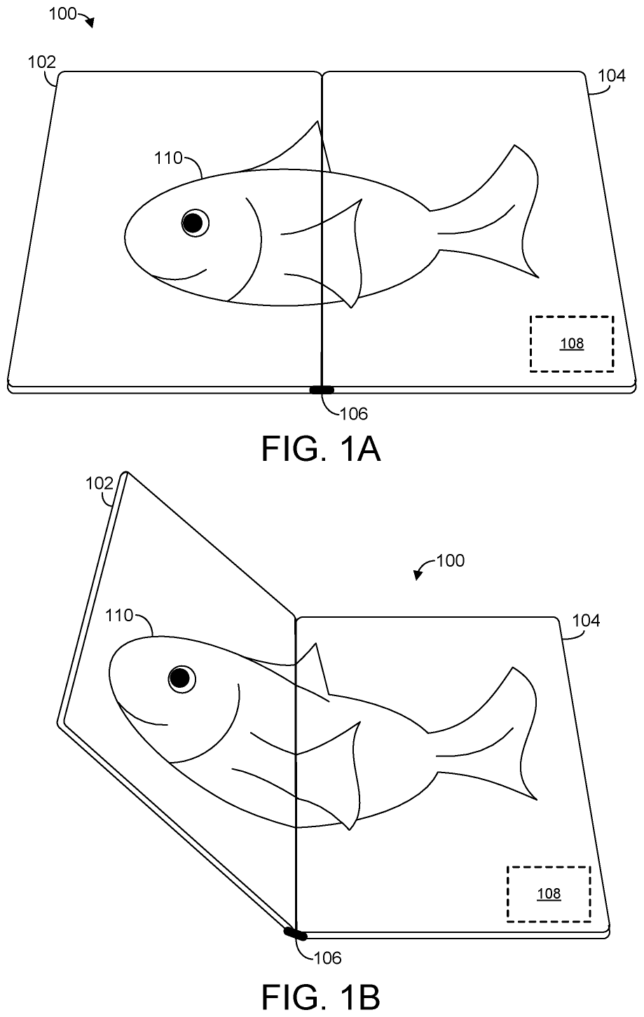

FIGS. 1A and 1B schematically show an example electronic display system 100 including two displays 102 and 104. The displays 102 and 104 each may have any suitable sizes and dimensions. The present disclosure primarily focuses on an electronic display system having two displays, although this is not limiting. In other examples, an electronic display system may include more than two displays. Each of the displays of the electronic display system need not have the same size, shape, or resolution.

Furthermore, each of the displays may use any suitable technology for displaying images rendered by the electronic display system—e.g., the displays may be transmissive displays (e.g., using liquid-crystal display (LCD) technology) or emissive displays (e.g., using organic light-emitting diode (OLED) technology). The displays of the electronic display system need not each use the same underlying image-forming technology. Furthermore, in some cases, either or both of displays 102 and 104 may be touch-sensitive displays—e.g., the displays may be equipped with respective pluralities of touch-sensing electrodes configured to respond to proximity of suitable input objects, such as styluses and human fingers.

Displays 102 and 104 may in some cases be substantially rigid—e.g., each display may not be configured to bend or flex any significant amount during normal use. In other examples, however, one or both of displays 102 and 104 may be flexible displays, having any suitable range of motion.

Electronic display system 100 further comprises a hinge 106 disposed between the first display 100 and the second display 102. In this manner, an angular relationship between the first and second displays may be dynamically adjusted. Hinge 106 may have any suitable range of motion. For instance, hinge 106 may enable electronic display system 100 to be folded in half to achieve a “closed” configuration analogous to a closed book, such that the surfaces of the two displays are parallel and facing toward one another (e.g., ˜0° angle between the two displays). In some examples, a hinge may support an ˜360° angle that positions the displays in a front/back configuration facing away from one another. Furthermore, the hinge may enable the display system to be opened to a flat “open” configuration where the surfaces of the displays are substantially coplanar (e.g., ˜180° angle between the two displays). FIG. 1A schematically depicts electronic display system 100 in an “open” configuration, where the surfaces of displays 102 and 104 are substantially coplanar. By contrast, FIG. 1B schematically depicts electronic display system 100 in a configuration where display 102 has rotated about hinge 106 relative to display 104, such that there is approximately a 130° angle between the first and second displays.

In general, two or more displays of an electronic display system may have any angular relationship with respect to one another, ranging between a minimum angular difference (e.g., 0°) and a maximum angular difference supported by the hinge (e.g., 180° or 360°). Furthermore, an electronic display system may have any number of hinges, each having any suitable range of motion. Multiple hinges may, for example, enable rotation of one or more displays (and/or other portions of the device) about any rotational axes.

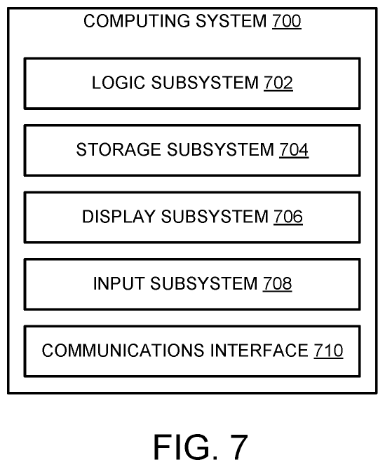

In some cases, an electronic display system may share a common housing with suitable computer hardware—e.g., such as in a mobile phone or tablet computer. In other examples, however, the electronic display system may be configured to present visual content received from a separate source via a suitable wired or wireless connection. In any case, an electronic display system may have any suitable capabilities, form factor, and hardware configuration. An electronic display system may in some cases be implemented as computing system 700 described below with respect to FIG. 7.

In the example of FIGS. 1A and 1B, electronic display system 100 includes a display controller 108. Display controller 108 may perform any suitable computer operations related to displaying visual content on the first and second displays. The display controller may be implemented as a computer processor, a system-on-a-chip (SoC), an application-specific integrated circuit (ASIC), and/or any other combination of one or more suitable computer logic components. Display controller 108, and/or any other components involved in rendering visual content for display by the electronic display system, may in some cases be implemented as logic subsystem 702 described below with respect to FIG. 7.

In some cases, display controller 108 may render the visual content to be presented by the first and second displays. For example, the visual content may be rendered based at least in part on data output by software running on the electronic display system (such as an operating system, user-installable applications, firmware, etc.). In other examples, display controller 108 may receive rendered visual content from a separate logic component of electronic display system 100 and/or another suitable computing device.

In any case, the display controller prepares rendered image content for display by the first and/or second displays of electronic display system 100. In some cases, the image content may initially be rendered without regard to the fact that the total displayable area of the electronic display system is split between two separate displays. For example, a compositor of the electronic display system (e.g., implemented as part of display controller 108, and/or as part of another suitable computer logic component) may composite visual content output by software of the electronic display system as a single rendered image, having a size that is fit to the total displayable area of the first and second displays together. This may beneficially enable the electronic display system to be used with software (e.g., user-installable software applications) that is not specifically programmed for use with a dual-display device—rather, such software may render image content as if for a single-display device, and the display controller may split the image content for presentation by two displays. The resolution of the rendered image may be the same as, or different from, the resolution of one or both displays. The display controller may then assign different image pixels of the rendered image content for display by one or the other of first display 102 and second display 104 of electronic display system 100.

In the example of FIGS. 1A and 1B, the electronic display system is currently displaying rendered image content 110. It will be understood that the specific image content shown in FIGS. 1A, 1B, and the other FIGS. herein is non-limiting and used only for the sake of illustration. As shown, the two displays are used cooperatively to display the same rendered image content—e.g., the display controller assigns different portions of the overall rendered image content to both of the displays, such that the displays together present the entire image.

It will be understood that, in other examples, the two displays need not be used to collectively form a single image, as is shown in FIGS. 1A and 1B, but rather each display may independently present different visual content. For instance, the rendered visual content may include a plurality of graphical elements—e.g., images, videos, text, and/or user interface elements. Furthermore, each display need not be used at the same time—e.g., depending on the current configuration of the electronic display system, one display may present image content while the other display is inactive.

The present disclosure uses the term “rendered visual content” to refer to virtually any visual content that can be presented by one or more displays of an electronic display system. As discussed above, this can include images, videos, text, user-interface (UI) elements, and/or any other suitable visual content. Furthermore, rendered visual content may be updated or replaced at any suitable framerate—such as 30 frames-per-second (FPS) or 60 FPS, as examples. In some cases, the framerate at which rendered visual content is updated may be variable over time—e.g., depending on the current computational workload of the electronic display system. In some cases, two or more displays of an electronic display system need not use the same framerate to update rendered image content.

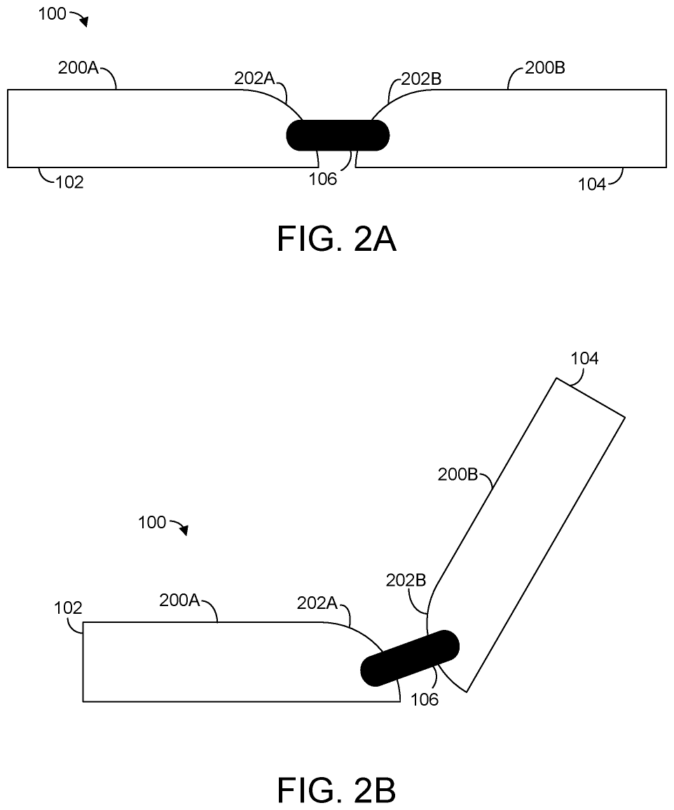

As discussed above, in some cases, the current angle of one display relative to another (referred to as a “hinge angle”) may be used by the display controller as an input for determining which pixels of the rendered image content should be presented by different pixels of the first and second displays. This may beneficially enable the electronic display system to present visual content that appears to flow continuously from one display to another, without the appearance that any content is missing or invisible between the two displays. FIGS. 2A and 2B provide a side view of electronic display system 100 at two different hinge angles. Specifically, FIG. 2A again shows display 102 and display 104 of electronic display system 100, with hinge 106 disposed between the two displays.

First display 102 includes a first flat portion 200A and a first edge portion 202A that curves away from the flat portion. Similarly, second display 104 includes a second flat portion 200B and a second edge portion 202B that curves away from the flat portion. Hinge 106 is disposed between the first edge portion of the first display and the second edge portion of the second display, and pivotally couples the first display to the second display, as discussed above. In some examples, at least part of the edge portions of first display 102 and second display 104 may be visible when the electronic display system is folded to a “closed” configuration—e.g., a ˜0° angle between the display surfaces. This may, for instance, provide a technical benefit by enabling the electronic display system to present some information to a human user, such as pending notifications, even in the closed configuration. It will be understood, however, that the specific geometry of the electronic display system shown in FIGS. 2A and 2B, as well as the other FIGS. described herein, is non-limiting and provided only for the sake of example.

In the example of FIG. 2B, the angle of second display 104 relative to first display 102 has changed. As a result, at least some of first edge portion 202A and/or second edge portion 202B may be relatively more difficult, if not impossible, for a human user to see from a typical viewing position. This has the effect of reducing the total display surface of the electronic display system visible to a human user while in the partially folded configuration of FIG. 2B, as compared to the “open” configuration shown in FIG. 2A. This may affect the visibility of any visual content presented by the electronic display system—e.g., rendered visual content 110 in FIGS. 1A and 1B. Furthermore, the extent to which the displayable area of the electronic display system is affected may depend on the angle between the two displays—e.g., relatively smaller angles (closer to a “closed” configuration) may result in relatively less displayable area than larger angles (closer to an “open” configuration).

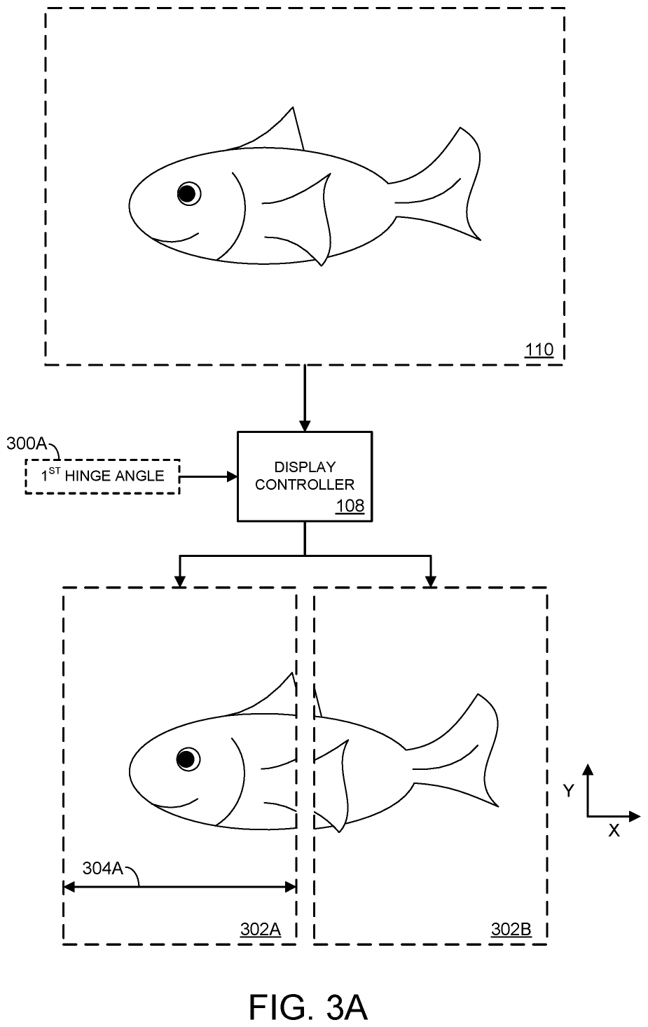

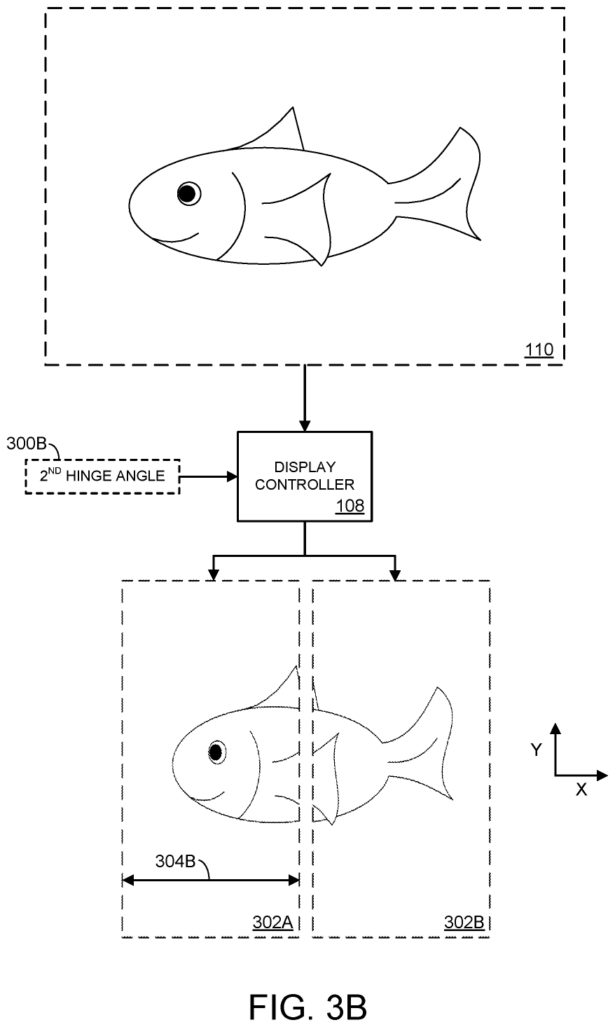

Accordingly, as discussed above, the display controller may in some cases dynamically adjust a rendered size of the portions of the visual content presented by the first and second displays, to beneficially use portions of each display that the display controller determines are likely to be visible to a user. This is schematically illustrated with respect to FIGS. 3A and 3B. Specifically, FIG. 3A shows rendered visual content 110 prior to adjustment by the display controller. As discussed above, the visual content may initially be rendered without regard to the fact that the total displayable area of the electronic display system is split between two or more different displays. Rather, the visual content may be rendered as a single frame, such as is shown in FIG. 3A.

FIG. 3A also schematically represents display controller 108. As discussed above, display controller 108 may in some cases render visual content 110 based at least in part on data output by software of the electronic display system and/or another source device, or the display controller may receive the rendered visual content from another component. In any cases, the display controller prepares the rendered visual content for presentation by the displays of the electronic display system.

This may be done based at least in part on a current hinge angle of the electronic display system—e.g., the current angular separation between the first display and the second display. Thus, in FIG. 3A, display controller 108 receives a first hinge angle 300A between the first display and the second display pivotally coupled via the hinge. The hinge angle of the electronic display system may be determined in any suitable way. In general, the electronic display may include any suitable sensor or combination of sensors for determining the current angular separation between two displays.

As one non-limiting example, the electronic display system may include a hinge-angle sensor and/or one or more abutment sensors. A hinge-angle sensor may be configured to furnish an output responsive to the angle of separation between flat portion 200A and flat portion 200B of respective displays 102 and 104. An abutment sensor may be configured to furnish an output responsive to abutment of a display (such as display 102) to any other display (such as display 104). In some examples, a hinge-angle sensor and/or abutment sensor may include a potentiometer, an electrostatic sensor, or Hall-effect sensor. In other examples, various other sensor technologies may be used.

In any case, based at least in part on the hinge angle, the display controller may divide the rendered visual content into two different portions for presentation by displays 102 and 104 of electronic display system 100. This is schematically shown in FIG. 3, in which rendered visual content 110 is divided into a first portion 302A and a second portion 302B. First portion 302A of the rendered visual content may be displayed by first display 102, and second portion 302B of the rendered visual content may be displayed by second display 104. See, for example, FIGS. 1A and 1B, in which displays 102 and 104 are depicted as presenting first and second portions 302A and 302B of rendered visual content 110.

Furthermore, the first and second portions of the rendered visual content may have rendered sizes based at least in part on the first hinge angle between the displays. This is shown in FIG. 3A, in which first portion 302A has a rendered size 304A relative to a horizontal axis—e.g., the X axis as labeled in FIG. 3A. As will be described in more detail below, a change in the hinge angle between the first display and the second display may cause the display controller to change the rendered size of the first portion and the second portion of the rendered visual content. The rendered size may be changed along one or more directional axes.

This is schematically illustrated with respect to FIG. 3B, again showing display controller 108 splitting rendered visual content 110 into first and second portions 302A and 302B. In this example, the display controller receives a second hinge angle 300B between the first display and the second display, different from the first hinge angle. As such, the display controller changes the rendered sizes of the first portion of the rendered visual content and the second visual content based at least in part on the second hinge angle.

Specifically, in this example, second hinge angle 300B is smaller than first hinge angle 300A, which may reduce the amount of displayable area visible to a human user as discussed above. Thus, the display controller reduces the rendered sizes 304B of the first and second portions of the rendered visual content. In this example, the rendered sizes are reduced relative only to the direction perpendicular to the hinge axis—e.g., the X axis. This may beneficially change the change the area used to display content along the dimension affected by the change in hinge angle (e.g., the X axis), without changing the content along the dimension unaffected by the change in hinge angle (e.g., the Y axis), thereby beneficially tailoring presentation of content to the capabilities of the device. However, in other examples, the rendered size of the visual content may be changed relative to one or both directional axes of the two-dimensional display area.

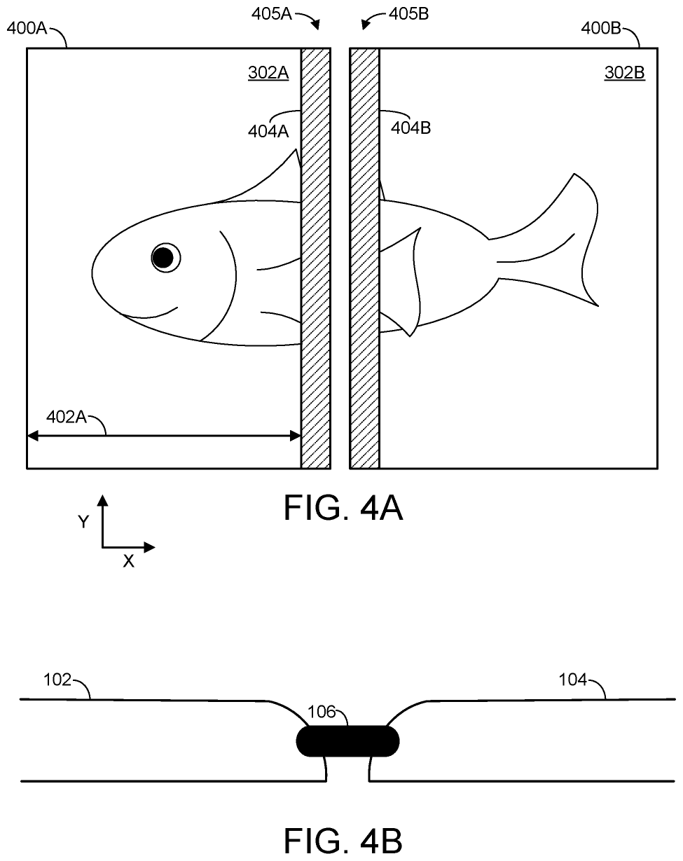

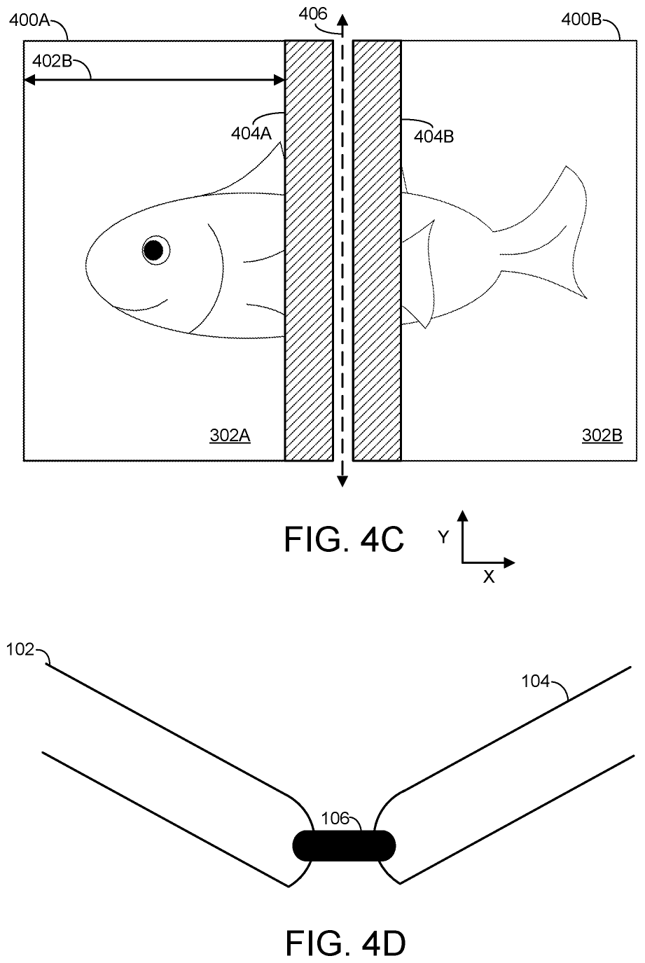

This is further schematically illustrated with respect to FIGS. 4A-4D. Specifically, FIG. 4A schematically depicts two different pluralities of display pixels 400A and 400B, corresponding to first display 102 and second display 104. Display pixels 400A and 400B represent the total displayable area of each of displays 102 and 104 as two-dimensional planes, without regard to the fact that displays 102 and 104 curve toward the hinge at the edge portions.

More particularly, as is shown in FIG. 4A, first and second portions 302A and 302B of the visual content each have a first rendered size, indicated by the length of arrow 402A. In the illustrated example, this size refers to one dimension of the two-dimensional displayable area—specifically, the horizontal dimension parallel to the X axis as labeled in FIG. 4A. In other examples, the size of each portion of the rendered visual content may be adjusted relative to either or both dimensions of the total displayable area of each display, based at least in part on the overall configuration of the electronic display system.

Notably, in FIG. 4A, the size of first portion 302A and second portion 302B is such that not all of the plurality of display pixels 400A and 400B are used for presenting first portion 302A and second portion 302B. In other words, a rendered size of the first portion of the rendered visual content is smaller than a total displayable area of the first display, and a rendered size of the second portion of the rendered visual content is smaller than a total displayable area of the second display. As such, the first display includes a first mask 404A and the second display includes a second mask 404B. In this example, the first mask is disposed along a hinge-proximal edge 405A of the first display, and the second mask is disposed along a hinge-proximal edge 405B of the second display. It will be understood, however, that any suitable portions of a display area may be masked depending on the specific configuration of the electronic display system.

These masks may, for example, be applied to at least some of the pixels that the display controller determines may be difficult or impossible for a human user to see from a typical viewing position. Each mask may refer to a set of pixels that are not used in presenting the visual content. As one example, display pixels of the first mask and the second mask may be inactive. For example, in emissive display technologies, inactive pixels may be off—e.g., not currently emitting light. In transmissive display technologies, light from an underlying backlight may still be on, although the pixels are not configured to transmit light of any particular color—e.g., the pixel color may be black. Use of inactive display pixels in the first mask and second mask may beneficially result in power savings for the computing device, by reducing the amount of electrical power used to control the display pixels.

As another example, display pixels of the first mask and the second mask may be controlled with a same pixel color value. For example, the mask pixels may be controlled with a black or “null” pixel value, controlled with pixel values based at least in part on a current user interface color theme, controlled with pixel values chosen to resemble a color of the display housing of the electronic display system, and/or controlled with pixel values selected based at least in part on content currently presented by one or both displays (e.g., content presented near the hinge). In this manner, the rendered visual content may appear to smoothly transition from one display to another across hinge 106 from the user's perspective, without the appearance that any of the visual content is missing. As such, this may beneficially tailor presentation of content to the capabilities of the device and improve human-computer interaction—e.g., pixels that are easily visible are used to display graphical content, while pixels that may be partially or entirely hidden due to the current hinge angle are controlled with pixel values that make them potentially less distracting. For instance, pixels of the first and second mask regions may appear to blend in with the device housing, or with the currently-displayed graphical content.

Notably, in FIG. 4A, the relative sizes of the first and second image portions and the first and second masks are consistent with the electronic display system using the open configuration—e.g., a ˜180° between the first and second displays. This is schematically illustrated in FIG. 4B, showing a side view of displays 102 and 104, corresponding to display pixels 400A and 400B. However, as discussed above, the relative sizes of the image portions and masks may be dynamically changed by the image controller based at least in part on the current hinge angle.

Thus, FIG. 4C again schematically shows display pixels 400A and 400B, where the first and second portions 302A and 302B of the visual content have a second, smaller size, as indicated by the length of arrow 402B. In other words, the display controller has reduced the size of first portion 302A and second portion 302B based at least in part on the new hinge angle of the electronic display system. In some examples, changing the rendered sizes of the first portion of the rendered visual content and the second portion of the rendered visual content based at least in part on the second hinge angle further includes changing sizes of the first mask and the second mask. Thus, as shown in FIG. 4C, the mask regions 404A and 404B are correspondingly larger—e.g., changing the sizes of the first mask and the second mask includes increasing the sizes of the first mask and the second mask. This is representative of a scenario where the electronic display system has a partially folded configuration, as is shown in the side-view of FIG. 4D.

Furthermore, in the example of FIG. 4C, the rendered sizes of the first portion of the rendered visual content and the second portion of the rendered visual content are changed relative to a dimension perpendicular to a hinge axis 406—e.g., changed along the X axis as labeled in FIG. 4C. However, as discussed above, the rendered sizes of the portions of the visual content may be changed relative to one or both axes of the two-dimensional display area.

As used herein, reducing (or otherwise changing) the size of an image portion may be done in any suitable way. As one example, this may include globally resizing each image portion—e.g., each individual element (such as images, UI elements, text characters) exhibits the same relative change in size. As another example, some visual elements may remain the same size, while the space between different visual elements changes—e.g., text size and UI element size may be unaffected, while the space between different visual elements is increased or decreased. In other words, the rendered visual content may include a plurality of different graphical elements, and changing the rendered sizes of the first portion of the rendered visual content and the second portion of the rendered visual content includes changing one or both of a size and spacing between one or more graphical elements of the plurality of graphical elements. As another example, some amount of visual content may be cut off—e.g., folding the display system toward the closed configuration may cause some visual content at the outer edges of each display to be cut-off, while content near the inner edges (proximate to the hinge) appears to continuously flow from one display to the other. These different approaches may beneficially provide flexibility in how graphical content is displayed given the nature of the content and the current configuration of the device, thereby improving human-computer interaction.

The display controller may use any suitable calculations or relationships to determine the size of each portion of the visual content, based at least in part on the current hinge angle of the electronic display system. As one example, based at least in part on a known structure of the electronic display system, and based at least in part on a known geometry of each display, the display controller may be programmed with an algorithm that outputs a target size of each portion of the visual content based on at least the hinge angle as an input. As another example, the display controller may maintain a look-up table that specifies target sizes for the different portions of the visual content for different hinge angles.

It will be understood that the display controller may consider any number of variables in addition to the hinge angle in determining the size of each portion of the visual content. For example, the display controller may receive inputs from one or more software applications of the electronic display system—e.g., indicating that a UI element should remain entirely on one display or the other, and not split between the two displays. In cases where one or both of the first and second displays are flexible, a current flex angle of either or both displays may be considered. As another example, the display controller may consider the orientation of the electronic display system with respect to gravity—e.g., based at least in part on output from an accelerometer. As another example, the display controller may consider a current eye position and/or gaze direction of a human user—e.g., as inferred from a camera communicatively coupled with the electronic display system. Any or all of these approaches may beneficially enable the display controller to adjust the size of each portion of the visual content based at least in part on the parts of each display that the display controller determines are likely to be visible to a user.

Furthermore, in FIGS. 4A and 4B, the first and second portions of the visual content have substantially equal sizes. It will be understood, however, that this need not be the case. For instance, in scenarios where the size and/or shape of the two displays are different, the portion of the visual content presented by each display may similarly differ in size and/or shape, and the size and/or shape of each pixel mask may correspondingly differ. This may beneficially enable the techniques discussed herein to be applied to electronic display systems having more diverse form factors and/or applied to scenarios where display systems are used in more diverse use cases.

The present disclosure has thus far primarily focused on a scenario where both of displays 102 and 104 are used at the same time. It will be understood, however, that this need not be the case. Rather, depending on the current device configuration, only one display or the other may be used. Furthermore, the manner in which visual content is presented may in some cases depend on whether one or both displays of the electronic display system are used.

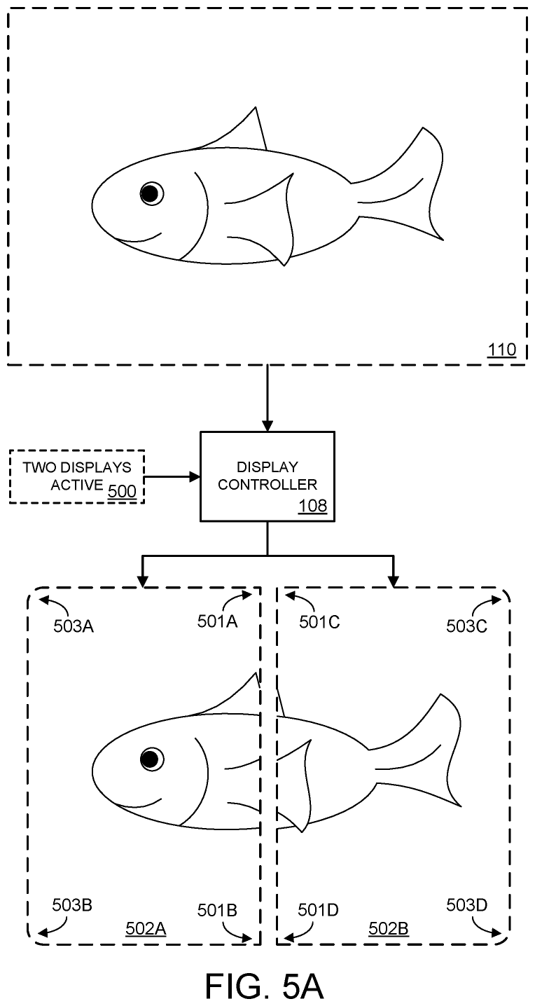

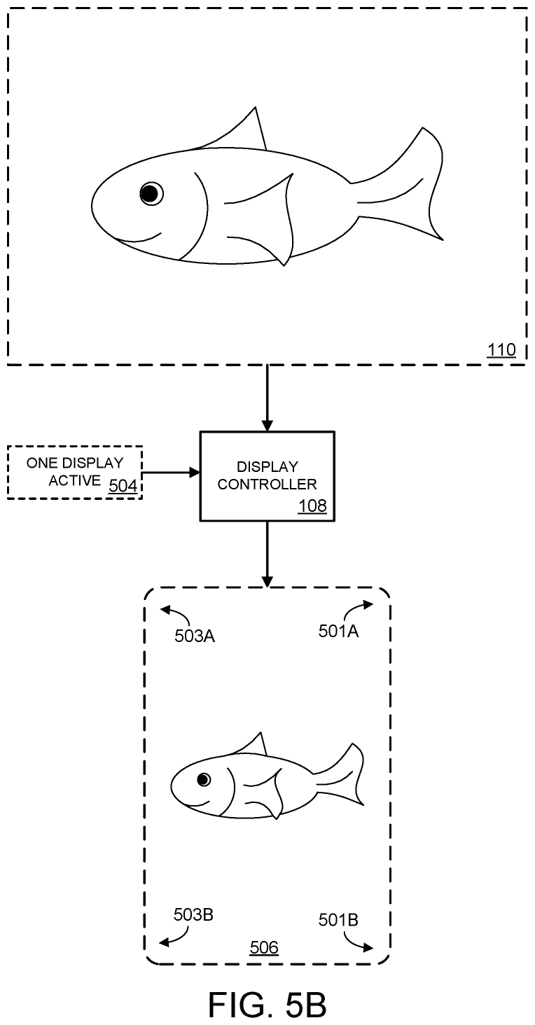

This is schematically illustrated with respect to FIGS. 5A and 5B. Specifically, FIG. 5A again schematically illustrates display controller 108 splitting rendered visual content 110 into two different portions. In the example of FIG. 5A, display controller 108 receives an indication 500 that both of displays 102 and 104 of electronic display system 100 are currently in use—e.g., the electronic display system is operating in a dual display mode. As such, the display controller causes display of the first portion 502A of the rendered visual content and the second portion 502B of the rendered visual content with squared corners proximal to the hinge and rounded corners distal from the hinge. As shown in FIG. 5A, corners 501A, 501B, 501C, and 501D proximal to the hinge have squared corners, while corners 503A, 503B, 503C, and 503D distal from the hinge have rounded corners. This may beneficially give the impression that the overall image presented by the two displays together takes the form of a single rectangle having four rounded corners, with visual content on one display appearing to flow continuously to the other display.

By contrast, FIG. 5B illustrates a different scenario, where the display controller receives an indication 504 that only one display is currently active—e.g., the electronic display system is operating in a single display mode. For example, the electronic display system may have a configuration in which there is an ˜360° between the display surfaces, such that one display (e.g., display 104) is behind and facing opposite from the other display (e.g., display 102). As such, the display controller adjusts rendered visual content 110 to a different rendered image 506 sized to fit on a single display. Based at least in part on detecting that the electronic display system is operating in the single display mode, the rendered visual content is displayed on the first display with four rounded corners. As shown in FIG. 5B, the four corners of the first display 501A, 501B, 503A, and 503B are rounded. This may beneficially improve the consistency with which visual content is displayed—e.g., the visual content appears as a rounded rectangle regardless of whether it is presented via one display or two.

Any suitable techniques may be used to affect the appearance of the corners of a displayed image. As one example, pixels in the corner regions of the display may be selectively masked to provide a rounded or squared appearance, depending on the scenario. It will be understood, however, that the corner masking techniques described above are non-limiting examples. In other examples, different corners of the visual content presented on different displays may be masked in any suitable way to achieve any suitable overall appearance—e.g., other corner profiles may be used besides rounded corners and squared corners.

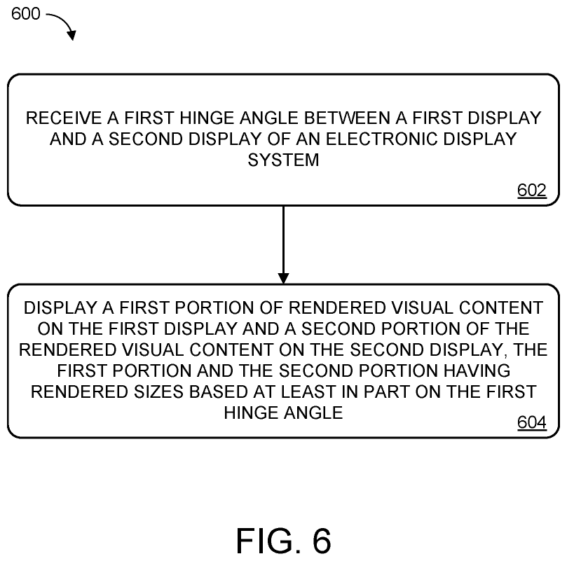

FIG. 6 illustrates an example method 600 for an electronic display system. Method 600 may be implemented by any suitable computing system of one or more computing devices. Any computing device performing steps of method 600 may have any suitable capabilities and hardware configuration. In some cases, method 600 may be implemented by electronic display system 100 described above, and/or computing system 700 described below with respect to FIG. 7.

At 602, method 600 includes receiving a first hinge angle between a first display and a second display pivotally coupled to the first display via a hinge. This may be done substantially as described above—e.g., display controller 108 receives a first hinge angle 300A in FIG. 3A, corresponding to the angle between first display 102 and second display 104 of electronic display system 100.

At 604, method 600 includes displaying a first portion of rendered visual content on the first display and a second portion of the rendered visual content on the second display, where the first portion and the second portion have rendered sizes based at least in part on the first hinge angle. This may be done substantially as described above—e.g., first portion 302A and second portion 302B are presented by first display 102 and second display 104 with rendered sizes based at least in part on the first hinge angle.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 7 schematically shows a simplified representation of a computing system 700 configured to provide any to all of the compute functionality described herein. Computing system 700 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 700 includes a logic subsystem 702 and a storage subsystem 704. Computing system 700 may optionally include a display subsystem 706, input subsystem 708, communication subsystem 710, and/or other subsystems not shown in FIG. 7.

Logic subsystem 702 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 704 includes one or more physical devices configured to temporarily and/or permanently hold computer information such as data and instructions executable by the logic subsystem. When the storage subsystem includes two or more devices, the devices may be collocated and/or remotely located. Storage subsystem 704 may include volatile, nonvolatile, dynamic, static, read/write, read-only, random-access, sequential-access, location-addressable, file-addressable, and/or content-addressable devices. Storage subsystem 704 may include removable and/or built-in devices. When the logic subsystem executes instructions, the state of storage subsystem 704 may be transformed—e.g., to hold different data.

Aspects of logic subsystem 702 and storage subsystem 704 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 706 may be used to present a visual representation of data held by storage subsystem 704. This visual representation may take the form of a graphical user interface (GUI). Display subsystem 706 may include one or more display devices utilizing virtually any type of technology. In some implementations, display subsystem may include one or more virtual-, augmented-, or mixed reality displays.

When included, input subsystem 708 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 710 may be configured to communicatively couple computing system 700 with one or more other computing devices. Communication subsystem 710 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, an electronic display system comprises: a display controller configured to: receive a first hinge angle between a first display and a second display pivotally coupled to the first display via a hinge; and display a first portion of rendered visual content on the first display and a second portion of the rendered visual content on the second display, the first portion and the second portion having rendered sizes based at least in part on the first hinge angle. In this example or any other example, a rendered size of the first portion of the rendered visual content is smaller than a total displayable area of the first display, a rendered size of the second portion of the rendered visual content is smaller than a total displayable area of the second display, and the first display includes a first mask and the second display includes a second mask. In this example or any other example, the display controller is further configured to receive a second hinge angle between the first display and the second display, different from the first hinge angle, and change the rendered sizes of the first portion of the rendered visual content and the second portion of the rendered visual content based at least in part on the second hinge angle. In this example or any other example, changing the rendered sizes of the first portion of the rendered visual content and the second portion of the rendered visual content based at least in part on the second hinge angle further includes changing sizes of the first mask and the second mask. In this example or any other example, the second hinge angle is smaller than the first hinge angle, changing the rendered sizes of the first portion of the rendered visual content and the second portion of the rendered visual content includes reducing the rendered sizes of the first portion of the rendered visual content and the second portion of the rendered visual content, and changing the sizes of the first mask and the second mask includes increasing the sizes of the first mask and the second mask. In this example or any other example, the rendered sizes of the first portion of the rendered visual content and the second portion of the rendered visual content are changed relative to a dimension perpendicular to a hinge axis. In this example or any other example, the rendered visual content includes a plurality of graphical elements, and changing the rendered sizes of the first portion of the rendered visual content and the second portion of the rendered visual content includes changing one or both of a size and spacing between one or more graphical elements of the plurality of graphical elements. In this example or any other example, the first mask is disposed along a hinge-proximal edge of the first display, and the second mask is disposed along a hinge-proximal edge of the second display. In this example or any other example, display pixels of the first mask and the second mask are inactive. In this example or any other example, display pixels of the first mask and the second mask are controlled with a same pixel color value. In this example or any other example, the first display includes a first flat portion and a first edge portion curving away from the first flat portion, and the second display includes a second flat portion and a second edge portion curving away from the second flat portion. In this example or any other example, the hinge is disposed between the first edge portion of the first display and the second edge portion of the second display. In this example or any other example, the display controller is configured to display the first portion of the rendered visual content and the second portion of the rendered visual content with squared corners proximal to the hinge and rounded corners distal from the hinge. In this example or any other example, the display controller is further configured to, based at least in part on detecting that the electronic display system is operating in a single display mode, display the rendered visual content on the first display with four rounded corners.

In an example, a method for displaying rendered visual content comprises: receiving a first hinge angle between a first display and a second display of an electronic display system, the second display pivotally coupled to the first display via a hinge; and displaying a first portion of rendered visual content on the first display and a second portion of the rendered visual content on the second display, the first portion and the second portion having rendered sizes based at least in part on the first hinge angle. In this example or any other example, a rendered size of the first portion of the rendered visual content is smaller than a total displayable area of the first display, a rendered size of the second portion of the rendered visual content is smaller than a total displayable area of the second display, and wherein the first display includes a first mask and the second display includes a second mask. In this example or any other example, the method further comprises receiving a second hinge angle between the first display and the second display, different from the first hinge angle, and changing the rendered sizes of the first portion of the rendered visual content and the second portion of the rendered visual content based at least in part on the second hinge angle. In this example or any other example, changing the rendered sizes of the first portion of the rendered visual content and the second portion of the rendered visual content based at least in part on the second hinge angle further includes changing sizes of the first mask and the second mask. In this example or any other example, the first display includes a first flat portion and a first edge portion curving away from the first flat portion, and the second display includes a second flat portion and a second edge portion curving away from the second flat portion.

In an example, an electronic display system comprises: a first display including a first flat portion and a first edge portion curving away from the first flat portion; a second display including a second flat portion and a second edge portion curving away from the second flat portion; a hinge disposed between the first edge portion and the second edge portion, the hinge pivotally coupling the first display to the second display; and a display controller configured to: receive a first hinge angle between the first display and the second display; display a first portion of rendered visual content on the first display and a second portion of the rendered visual content on the second display, the first portion and the second portion having rendered sizes based at least in part on the first hinge angle; receive a second hinge angle between the first display and the second display; and change the rendered sizes of the first portion of the rendered visual content and the second portion of the rendered visual content based at least in part on the second hinge angle.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An electronic display system, comprising:
a display controller configured to:
receive a first hinge angle between a first display and a second display pivotally coupled to the first display via a hinge; and
display a first portion of rendered visual content on the first display and a second portion of the rendered visual content on the second display, the first portion and the second portion having rendered sizes based at least in part on the first hinge angle.

2. The electronic display system of claim 1, wherein a rendered size of the first portion of the rendered visual content is smaller than a total displayable area of the first display, a rendered size of the second portion of the rendered visual content is smaller than a total displayable area of the second display, and wherein the first display includes a first mask and the second display includes a second mask.

3. The electronic display system of claim 2, wherein the display controller is further configured to receive a second hinge angle between the first display and the second display, different from the first hinge angle, and change the rendered sizes of the first portion of the rendered visual content and the second portion of the rendered visual content based at least in part on the second hinge angle.

4. The electronic display system of claim 3, wherein changing the rendered sizes of the first portion of the rendered visual content and the second portion of the rendered visual content based at least in part on the second hinge angle further includes changing sizes of the first mask and the second mask.

5. The electronic display system of claim 4, wherein the second hinge angle is smaller than the first hinge angle, changing the rendered sizes of the first portion of the rendered visual content and the second portion of the rendered visual content includes reducing the rendered sizes of the first portion of the rendered visual content and the second portion of the rendered visual content, and wherein changing the sizes of the first mask and the second mask includes increasing the sizes of the first mask and the second mask.

6. The electronic display system of claim 3, wherein the rendered sizes of the first portion of the rendered visual content and the second portion of the rendered visual content are changed relative to a dimension perpendicular to a hinge axis.

7. The electronic display system of claim 3, wherein the rendered visual content includes a plurality of graphical elements, and wherein changing the rendered sizes of the first portion of the rendered visual content and the second portion of the rendered visual content includes changing one or both of a size and spacing between one or more graphical elements of the plurality of graphical elements.

8. The electronic display system of claim 2, wherein the first mask is disposed along a hinge-proximal edge of the first display, and the second mask is disposed along a hinge-proximal edge of the second display.

9. The electronic display system of claim 2, wherein display pixels of the first mask and the second mask are inactive.

10. The electronic display system of claim 2, wherein display pixels of the first mask and the second mask are controlled with a same pixel color value.

11. The electronic display system of claim 1, wherein the first display includes a first flat portion and a first edge portion curving away from the first flat portion, and the second display includes a second flat portion and a second edge portion curving away from the second flat portion.

12. The electronic display system of claim 11, wherein the hinge is disposed between the first edge portion of the first display and the second edge portion of the second display.

13. The electronic display system of claim 1, wherein the display controller is configured to display the first portion of the rendered visual content and the second portion of the rendered visual content with squared corners proximal to the hinge and rounded corners distal from the hinge.

14. The electronic display system of claim 13, wherein the display controller is further configured to, based at least in part on detecting that the electronic display system is operating in a single display mode, display the rendered visual content on the first display with four rounded corners.

15. A method for displaying rendered visual content, the method comprising:
receiving a first hinge angle between a first display and a second display of an electronic display system, the second display pivotally coupled to the first display via a hinge; and
displaying a first portion of rendered visual content on the first display and a second portion of the rendered visual content on the second display, the first portion and the second portion having rendered sizes based at least in part on the first hinge angle.

16. The method of claim 15, wherein a rendered size of the first portion of the rendered visual content is smaller than a total displayable area of the first display, a rendered size of the second portion of the rendered visual content is smaller than a total displayable area of the second display, and wherein the first display includes a first mask and the second display includes a second mask.

17. The method of claim 16, further comprising receiving a second hinge angle between the first display and the second display, different from the first hinge angle, and changing the rendered sizes of the first portion of the rendered visual content and the second portion of the rendered visual content based at least in part on the second hinge angle.

18. The method of claim 17, wherein changing the rendered sizes of the first portion of the rendered visual content and the second portion of the rendered visual content based at least in part on the second hinge angle further includes changing sizes of the first mask and the second mask.

19. The method of claim 15, wherein the first display includes a first flat portion and a first edge portion curving away from the first flat portion, and the second display includes a second flat portion and a second edge portion curving away from the second flat portion.

20. An electronic display system, comprising:
a first display including a first flat portion and a first edge portion curving away from the first flat portion;
a second display including a second flat portion and a second edge portion curving away from the second flat portion;
a hinge disposed between the first edge portion and the second edge portion, the hinge pivotally coupling the first display to the second display; and
a display controller configured to:
receive a first hinge angle between the first display and the second display;
display a first portion of rendered visual content on the first display and a second portion of the rendered visual content on the second display, the first portion and the second portion having rendered sizes based at least in part on the first hinge angle;
receive a second hinge angle between the first display and the second display; and
change the rendered sizes of the first portion of the rendered visual content and the second portion of the rendered visual content based at least in part on the second hinge angle.
